(19) United States
(12) Patent Application Publication
(10) Pub. No.: US 2026/0193066 A1
(43) Pub. Date: Jul. 9, 2026

(54) APPARATUS AND METHOD FOR THE MOUNTING AND REMOVAL OF STRUCTURES ON A VEHICLE

(71) Applicant: John D. Cullinan, Mason, OH (US)

(72) Inventor: John D. Cullinan, Mason, OH (US)

(21) Appl. No.: 19/552,515

(22) Filed: Feb. 27, 2026

Related U.S. Application Data
(63) Continuation-in-part of application No. 19/360,411, filed on Oct. 16, 2025.
Application No. 19/360,411 is a continuation of application No. 17/513,628, filed on Oct. 28, 2021, now Pat. No. 12,448,258.
(60) Provisional application No. 63/765,181, filed on Feb. 28, 2025.

(51) Int. Cl. B66F 5/02; B25H 1/00; B60D 1/66; B60J 7/10; B60S 9/08; B60S 9/18; B66C 23/48

(52) U.S. Cl. CPC B66F 5/025; B25H 1/0007; B60J 7/106; B66C 23/48; B60D 1/66; B60S 9/08; B60S 9/18

(57) ABSTRACT

A lift apparatus to mount and remove a structure on a vehicle includes a lower platform assembly configured to be positioned under a vehicle and an upper platform assembly that is positioned at a height above the lower platform assembly and configured for supporting a structure over a vehicle surface. A vertical support is mounted to the lower platform assembly and the upper support assembly is mounted to the vertical support. The vertical support extends in length for raising and lowering the upper platform assembly with respect to the lower platform assembly. A linear actuator extends vertically and generally parallel to the adjustable vertical support. The linear actuator is coupled at a first end to the lower platform assembly and coupled at a second end to the adjustable vertical support. The actuator is selectively variable in length for changing the length of the adjustable vertical support to raise and lower the upper platform with respect to the vehicle surface.

### RELATED APPLICATIONS

This application is a Continuation-in-Part application of U.S. patent application Ser. No. 19/360,411 filed Oct. 16, 2025, which application is a Continuation application of U.S. patent application Ser. No. 17/513,628, filed Oct. 28, 2021, now U.S. Pat. No. 12,448,258. U.S. Pat. No. 12,448,258 claims the benefit of U.S. Provisional Application No. 63/106,868, filed Oct. 28, 2020. This application also claims the benefit of U.S. Provisional Application No. 63/765,181, filed Feb. 28, 2025. The U.S. Patent and all such noted applications are incorporated by reference herein in their entireties.

### TECHNICAL FIELD OF THE INVENTION

The present disclosure relates generally to apparatuses and methods for mounting and removing a structure on a vehicle.

### BACKGROUND OF THE INVENTION

Many vehicles have removable elements placed thereon that are often heavy to lift and manipulate. For example, various vehicles have hardtops which can be removed, stored, and then reinstalled as needed for the vehicle use. Vehicles under the brand name JEEP® often have such tops. (As used herein, “hardtop”, unless otherwise indicated, refers to any removable vehicle top.) Pickup trucks also often have caps that are installed to sit over and cover the truck bed for keeping the elements out of the bed and off of any items that are carried in the bed.

The combination of the physical attributes, including, without limitation, size, shape and weight, and the location of the hardtop or cap on the vehicle presents difficulty for the removal, storage and reinstallation of such elements. Although lift apparatuses are known in the art, none of the prior art lifts provides the structure, function or advantages as described and claimed below.

Additionally, the need or desire to remove, store and reinstall a hardtop or truck cap is not limited to a single location, such as the garage in which the vehicle is typically kept. There is therefore a need for a portable lift which may be stowed, for example, with relative ease within the vehicle itself, and then transported to one or more other ad hoc locations and then quickly and easily assembled and disassembled as needed for its use. This allows vehicle owners to travel to any location with the hardtop or cap on the vehicle, remove the hardtop/cap at the location and reinstall the hardtop/cap at that same location, and then easily re-stow the lift within the vehicle.

Furthermore, there are now a number of accessories that are mounted on the rooftop of vehicles, such as SUVs and pickup trucks. Such accessories also often have significant weight that is more than one or even two people can readily and easily handle when the accessory is installed onto a vehicle top or roof and then is removed and stored away for later use. For example, rooftop mounted tents have become a popular accessory. Such tents usually have a heavy and rigid base for support and a robust structure to allow one or more people to use the tent as constructed and raised on the top or roof of the vehicle. Such structures can therefore weigh several hundred pounds. As may be appreciated, such tents are significant structures, are not always aerodynamic and so a user will not want them to remain on the vehicle rooftop indefinitely. However, mounting and removal of a tent or other heavy accessory because of the significant weight, can make the task a daunting one, even for a couple of people, much less a single person. The issue of storage also comes into play. Once the tent is removed, storing it on a ground surface, and then having to lift it from the ground all the way back up to a rooftop is a significant undertaking.

Therefore, there is a need in the industry to facilitate a more simple and easy installation and removal and storage of vehicle hardtops, truck caps and rooftop accessories. Such a need also exists in having a portable device that may be stowed and transported easily, thus increasing its versatility.

### SUMMARY OF THE INVENTION

A lift apparatus to mount and remove a structure on a vehicle includes a lower platform assembly configured to be positioned under a vehicle and an upper platform assembly that is positioned at a height above the lower platform assembly and configured for supporting a structure over a vehicle surface. A vertical support is mounted to the lower platform assembly and the upper support assembly is mounted to the vertical support. The vertical support is configured to extend in length for raising and lowering the upper platform assembly with respect to the lower platform assembly. A linear actuator extends vertically and generally parallel to the adjustable vertical support. The linear actuator is coupled at a first end to the lower platform assembly and coupled at a second end to the adjustable vertical support. The actuator is selectively variable in length for changing the length of the adjustable vertical support to thereby raise and lower the upper platform with respect to the vehicle surface.

### BRIEF DESCRIPTION OF THE DRAWINGS

The accompanying drawings together with the specification, including the detailed description which follows, serve to explain the principles of the present invention through one or more embodiments, as shown. The drawings are not in any way limiting with respect to the features described or claimed herein but rather act with the detailed description to provide examples of the invention.

FIG. 1 is a perspective view of a lift configured in accordance with one or more teachings of the present innovation shown lifting a load element.

FIG. 2 is a perspective view of the lift of the embodiment in FIG. 1.

FIG. 3 is a side view of the lift of the embodiment in FIG. 1 in a lowered position.

FIG. 4 is a side view of the lift of the embodiment in FIG. 1 in a raised position.

FIG. 5 is a partial cross-sectional view of a portion of telescoping elements of the lift configured in accordance with one or more teachings of the present invention.

FIG. 6 is an exploded perspective view of the portion of the telescoping elements of the lift as illustrated in FIG. 5.

FIG. 7 is a top view of an upper platform assembly configured in accordance with one or more teachings of the present invention.

FIG. 8 is a perspective view of another alternative embodiment of a lift configured in accordance with one or more teachings of the present invention.

FIG. 9 is another perspective view of a lift configured in accordance with one or more teachings of the present invention shown adjusted from the position of the lift in FIG. 8.

FIG. 10 is a partial perspective view of a lift configured in accordance with one or more teachings of the present invention as illustrated in FIG. 9.

FIG. 11 is a perspective view of another alternative embodiment of a lift configured in accordance with one or more teachings of the present invention.

FIG. 12 is a perspective and disassembled view of an upper platform assembly of a lift as illustrated in FIG. 11 configured in accordance with one or more teachings of the present invention.

FIG. 13 is a side view, in partial cross section, of elements of an upper platform assembly of a lift as illustrated in FIG. 11 configured in accordance with one or more teachings of the present invention.

FIG. 14 is a side view, in partial cross section, of elements of an upper platform assembly of a lift as illustrated in FIG. 11 configured in accordance with one or more teachings of the present invention.

FIG. 15 is an exploded perspective view of a portion of telescoping elements of the lift as illustrated in FIG. 11 configured in accordance with one or more teachings of the present invention.

FIG. 16 is a partial cross-sectional view of a portion of telescoping elements of the lift configured in accordance with one or more teachings of the present invention.

FIG. 17 is a side view, in partial cross section, of elements of a linear actuator and its interface with telescoping elements of a lift configured in accordance with one or more teachings of the present invention.

FIG. 18 is a side view, in partial cross section, of additional elements of a linear actuator and its interface with telescoping elements of a lift configured in accordance with one or more teachings of the present invention.

FIG. 19 is a side view, in partial cross section, of elements of a linear actuator and telescoping elements of a vertical support coupled to the lower platform assembly of a lift configured in accordance with one or more teachings of the present invention.

FIG. 20 is a perspective and disassembled view of lower platform assembly of a lift configured in accordance with one or more teachings of the present invention.

FIG. 21 is a side view, in partial cross section, of elements of view of a main support of a lift configured in accordance with one or more teachings of the present invention.

FIG. 22 is a perspective view of an alternative embodiment of a lift configured in accordance with one or more teachings of the present invention

FIG. 23 is a side view, in partial cross section, of elements of a linear actuator and telescoping elements at the main support of a lift of the embodiment illustrated in FIG. 22.

FIG. 24 is a perspective and disassembled view of main support of a lift configured in accordance with the embodiment of FIG. 22.

FIG. 25 is a perspective view of an alternative embodiment of a lift configured in accordance with one or more teachings of the present invention

FIG. 26 is a side view of an alternative embodiment of a lift as illustrated in FIG. 25.

It should be understood that the appended drawings are not necessarily to scale, presenting a somewhat simplified representation of various features illustrative of the basic principles of the invention. The specific design features or the sequence of operations as disclosed herein, including, for example, specific dimensions, orientations, locations, and shapes of various illustrated components, will be determined in part by the particular intended application and use environment. Certain features of the illustrated embodiments may be enlarged or distorted relative to others to facilitate visualization and clear understanding. In particular, thin features may be thickened, for example, for clarity or illustration.

### DETAILED DESCRIPTION OF EMBODIMENTS OF THE INVENTION

In the following description, like reference characters designate like or corresponding parts throughout the several views. Also, in the following description, it is to be understood that terms such as front, back, inside, outside, upper, lower and the like are words of convenience and are not to be construed as limiting terms. Terminology used in this patent is not meant to be limiting insofar as devices described herein, or portions thereof, may be attached or utilized in other orientations. Referring in more detail to the drawings, an embodiment constructed according to the teachings of the present innovation is described. Various of the noted elements might also be utilized in different combinations between the illustrated embodiments and so the illustrations are not limiting with respect to what upper and lower assemblies might be incorporated together. To the extent necessary, the disclosure as explicitly set forth herein supersedes any conflicting material incorporated herein by reference.

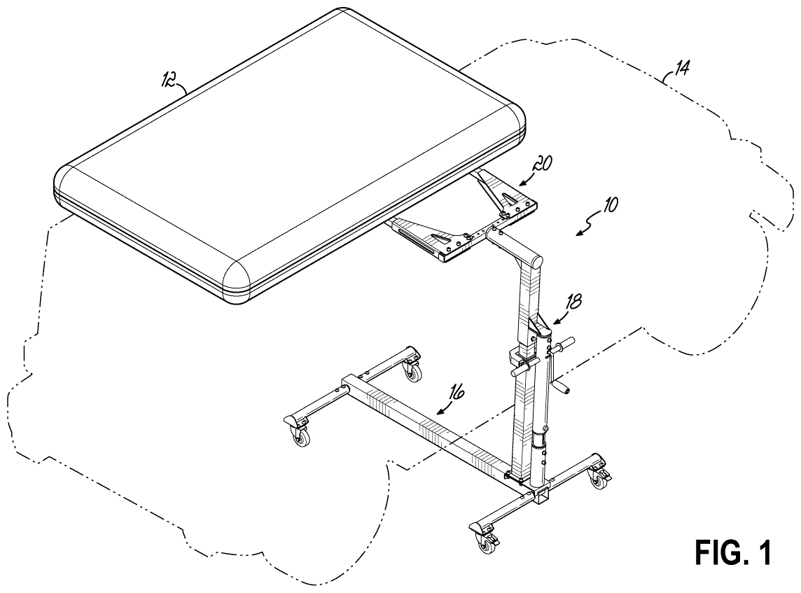

FIG. 1 illustrates an embodiment of an apparatus 10 for mounting and removing structures on a vehicle. Herein, in a general sense, since the apparatus 10 is used to lift and then raise and lower an element, such as a rooftop tent, a truck cap or a vehicle hardtop, with respect to a vehicle, the apparatus 10 will be referred to generally as a “lift”. Such a term is not limiting to the invention.

The lift 10, which is configured in accordance with one or more teachings and embodiments of the present invention, is shown suspending a structure, such as a rooftop tent 12 over a vehicle 14. Lift 10, in the embodiment depicted, comprises lower platform assembly 16 and an upper platform assembly 20. A vertical support 18 holds the upper platform assembly 20 above the lower platform assembly that rests on a ground or driveway/garage surface. In the embodiment of FIG. 1, the lower platform assembly 16 is illustrated as comprising main support 22 and a plurality of legs 24. As will be described below, lower platform assembly 16 is configured for quick and easy assembly and disassembly, and for compact storage. In the embodiment of FIG. 1, the legs extend to the sides of support 22 to provide the platform assembly 16. Lower platform assembly 16 is configured to fit under a vehicle while the upper platform assembly 20 is suspended above a vehicle rooftop and preferably underneath a tent element 12 or other cap or top element as shown in FIG. 1.

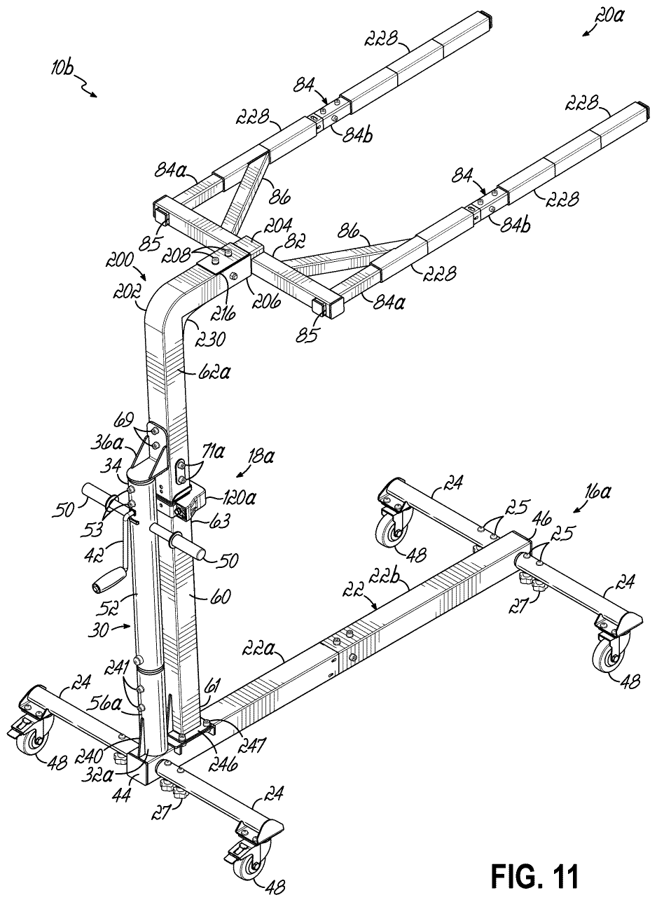

The lower platform assembly may include the main support 22 that may be in the form of an elongated beam made of a suitable metal material or other rigid material. The main support may be a single element as shown in FIG. 1 or may be comprised of multiple sections that are fixed together to form the main support. For example, the embodiment shown in FIG. 11 implements multiple sections 22a, 22b that are fixed together to form the main support 22. The length may be selected to ensure that the various legs 24 and the lift may be slid a sufficient distance under a vehicle and provide a stable base structure in the lower platform assembly 16 that can support the weight of whatever structure is supported, such as a tent. The legs 24 extend transversely from main support 22 at either end 44, 46 to form the stable lower platform assembly 16. Each of the legs 24 may be secured to the main support, such as with appropriate bolts 25 and nuts or fasteners 27. Legs 24 may be attached to main support 22 in any suitable manner which provides a secure connection therebetween with minimal to no movement at the connection. The proximal ends of the legs may be bolted or welded, for example, to the main support 22. The legs include rolling elements 48, such as wheels or casters, for creating a rolling lower platform assembly to move the platform to and under a vehicle in use. The wheel assemblies 48 are connected to distal ends of legs 24 and are spaced apart at locations which provide stable support of lift 10 sufficient to prevent toppling while supporting a structure. Wheel assemblies may be rigid (non-swiveling fork) casters such that they are oriented generally parallel to the longitudinal axis of main support 22. Or they could swivel to allow steering of lift 10. Or one or more of the wheel assemblies could be locked to be rigid while others move. For example, the wheel assemblies 48 may have lockable wheels, which allow locking lift 10 in place when a hardtop is being lifted from a vehicle. Wheel assemblies may also have lockable wheels which could be locked when the lift is in a stored location. Wheel assemblies 48 may be secured to legs 24 in any suitable manner which provides adequate stability to lift 10. For example, wheel brackets may be omitted and wheel assemblies might be secured directly to distal ends of legs 24.

The lift 10 includes a linear actuator 30, which creates motion in a straight line, and may be of any suitable configuration, such as, without limitation, a mechanical actuator, hydraulic actuator or pneumatic actuator. The linear actuator 30 is coupled with the adjustable vertical support 18 and, in accordance with one feature of the invention, is positioned on a side of the support 18 and is generally parallel therewith. The linear actuator is appropriately coupled with the adjustable vertical support as discussed herein such that actuation of the linear actuator 30 will telescope the adjustable vertical support 18 in length to affect the height of the upper platform assembly. Linear actuator 30 as depicted in the embodiment is illustrated to the rear side of the vertical support 18 and is in the form of a screw jack mechanism or mechanical actuator. Linear actuator 30 may also be referred to herein as jack assembly 30. While the linear actuator provides a motion and action for telescoping the adjustable vertical support 18 to raise and lower the lift and the upper platform assembly 20, the main vertical support for the weight of structure 12 is provided primarily by the adjustable vertical support 18. In accordance with one feature of the invention, the linear actuator, due to its parallel arrangement with the vertical support 18, provides a unique dual vertical support of the upper platform assembly 20 when handling the weight of the structure 12.

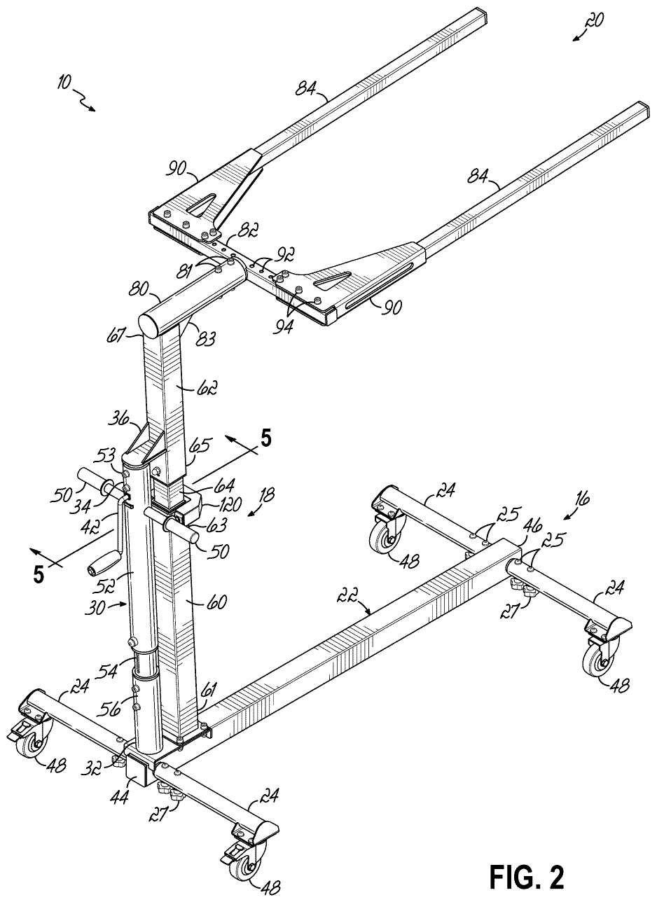

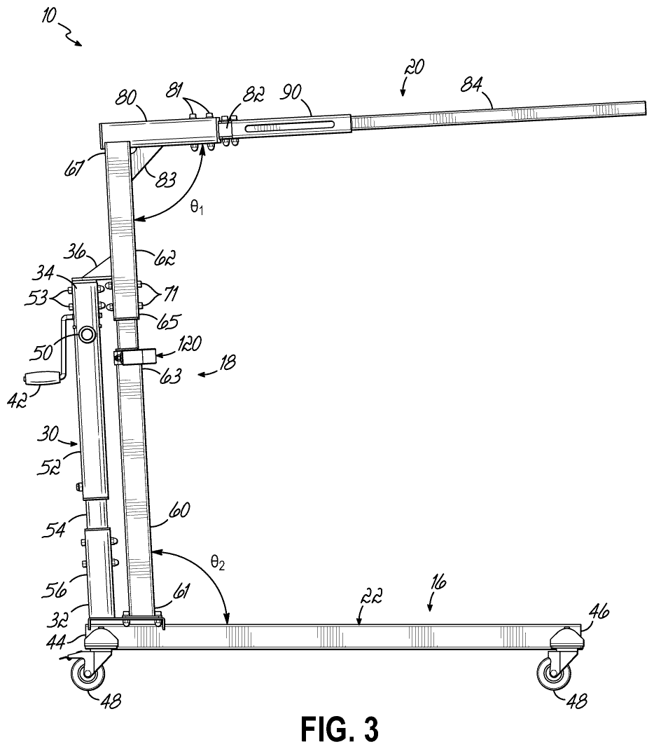

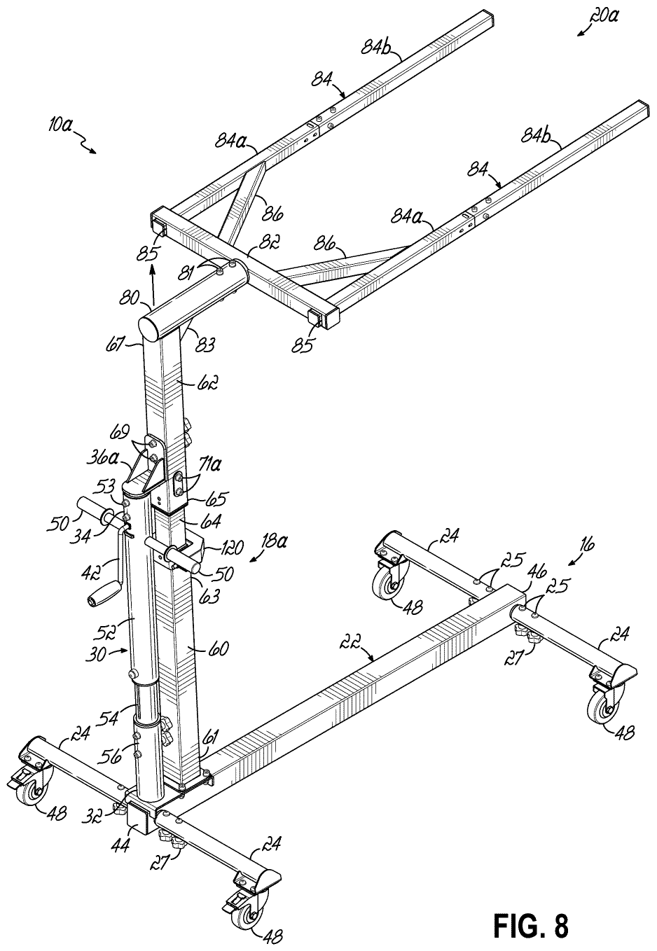

FIG. 3 illustrates a side view of the lift 10 and shows the dual vertical support formed by the adjustable vertical support 18 and the parallel linear actuator 30. The linear actuator 30 is mounted appropriately to the lift. For example, the base end 32 or lower end may be welded or bolted as shown to the lower platform assembly 16. Referring to FIGS. 2 and 3, the base end 32 may be positioned near one end of the main support 22 and welded or bolted thereto to extend vertically upwardly from the main support. Similarly, the upper end 34 of the linear actuator 30 is secured to a section of the vertical support 18. The upper end 34 may be welded or bolted as shown to a section of the adjustable vertical support 18. For example, in one embodiment as shown in FIGS. 2 and 3, the upper end 34 incorporates a mounting bracket 36 that is fixed to the upper end 34, such as by welding. Then the bracket 36 is welded or otherwise fixed to a section 65 of an outer tube 62 of the vertical support 18. As the linear actuator operates to raise and lower the upper end 34, the outer tube 62 and thus the upper platform assembly 20 that is fixed thereto as described herein, is raised and lowered. In an alternative embodiment of the invention as shown in FIG. 8, the upper end 34 incorporates a mounting bracket 36a that is configured to be bolted at a position along the length of the adjustable vertical support 18, such as by being bolted to outer tube 62 with bolts 69 to raise and lower the lift as described further herein.

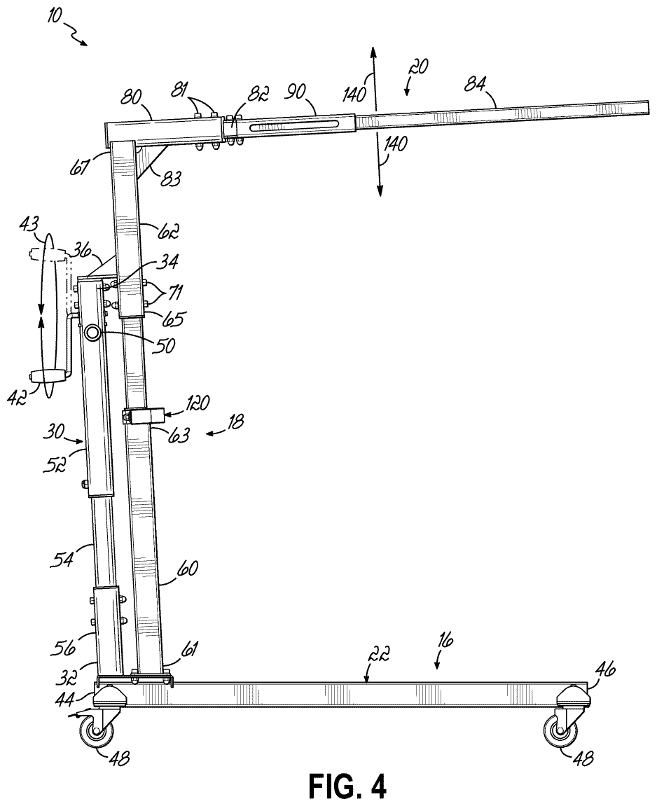

Referring also to FIGS. 3 and 4, the lift 10 is shown in a lowered position (FIG. 3) and a raised position (FIG. 4). The arrows 40 illustrate the movement of the upper platform when the linear actuator 30 telescopes the adjustable vertical support 18. Rotation of the crank 42 of the linear actuator 30 clockwise and counterclockwise (arrows 43) will lengthen and shorten the length of the linear actuator 30 and thus extend or shorten the length of the vertical support 18 as described to lower and raise upper platform 18 and any structure on the platform.

In the illustrated embodiment of the linear actuator 30 in FIG. 2, it includes a plurality of handles 50, such as for steering the lift 10. The linear actuator 30 includes a hand crank 42, outer actuator tube 52 and inner actuator tube 54. The lower end 55 of inner actuator tube 54 is carried and supported by a tubular base element 56 that is rigidly fixed to the end of the main support 22 proximate the adjustable vertical support 18. The end of the inner tube 54 might be disposed in a bushing which is disposed in an upper end of base element 56. The embodiment of linear actuator 30 might also include an anti-rotation pin which extends into an appropriate slot in the inner tube and prevents outer actuator tube 18 from rotating as linear actuator 30 is extended from and between a fully contracted position at which linear actuator 30 is fully contracted to a fully extended position at which linear actuator 30 is fully extended. One suitable linear actuator in disclosed in U.S. Pat. No. 12,448,258 entitled Apparatus and Method for Removal of Vehicle Hardtop, which Patent is incorporated herein by reference in its entirety. Actuation of the crank 42 by rotation as shown in FIG. 4 thereby extends or shortens the vertical length of the actuator 30 and raises or lowers the upper platform assembly 20.

The adjustable vertical support 18 as illustrated in FIGS. 3 and 4 includes a first outer tube 60 and a second outer tube 62. The first outer tube and the second outer tube that are configured to telescope with respect to each other. Specifically, the outer tubes 60, 62 receive, to telescope thereon, an inner tube 64 so that the tubes 60, 62 can move together or apart on the inner tube. The tubes 60-64 may have a square or rectangular cross-section, in one embodiment as illustrated. The cross-sectional shape of the tube is not limiting to the invention. The first outer tube 60 is appropriately rigidly coupled at the lower end 61 to the lower platform assembly, such as to an end of the main support 22 proximate to the linear actuator. It extends vertically from the lower platform assembly and generally parallel to the linear actuator 30. It may be bolted or welded, for example, to the lower platform assembly 16 or main support 22. The illustrated embodiment of FIGS. 3-4 show the vertical support bolted to the lower platform assembly 16 with appropriate bolts or fasteners. The upper end 63 of the first outer tube 60 receives a lower end of the inner tube. The inner tube is configured to move and telescope in the first outer tube. The upper end of the inner tube 64 is configured to fit into the lower end 65 of the second outer tube 62. One of the first and second outer tube may be fixed with the inner tube to move with the inner tube. For example, in one illustrated embodiment, the second outer tube 62 and the upper end of the inner tube may be fixed together, such as with appropriate bolts or other fasteners 71 as shown. In that way, the second outer tube 62 and inner tube 64 move together in a telescoping fashion with respect to the outer tube 60. However, the action might be reversed and the first outer tube and the lower end of the inner tube may be fixed together, such as with appropriate bolts or other fasteners and the second outer tube would move on the inner tube in a telescoping fashion with respect to the outer tube.

The lower end 65 of the second outer tube is also fixed to an end of the linear actuator, such as by bracket 36. Specifically, the upper end 34 of the outer actuator tube 52 and mounting bracket 36 are fixed to the lower end 65 of the second outer tube 62, such as by appropriate fasteners or by welding. In that way, movement of the upper end 34 of the outer actuator tube of the linear actuator 30 and bracket 36 will similarly move the second outer tube 62 and inner tube 64 to selectively extend and/or shorten the effective length of the adjustable vertical support 18. The upper platform assembly 20 that is coupled to the upper end 67 of the second outer tube 62 will then be raised and/or lowered with respect to the lower platform assembly 16 and ground or floor surface on which the lower platform assembly 16 sits. In that way, a structure 12 might be lowered and raised versus the vehicle 14. (See FIG. 1).

Referring again to FIGS. 2-4, the upper platform assembly 20 is coupled to the upper end 67 of the second outer tube 62. The upper platform assembly 20 includes an arm element 80 that may be rigidly coupled with the end 67, such as by welding or fasteners. The arm is generally horizontally oriented to dispose the upper platform assembly 20 at generally a right angle to the vertical support 18. Referring to FIG. 3, an angled support bracket 83 may be secured, such as by welding, between the second outer tube 62 and arm element 80 to further strengthen the juncture at the angle between those elements to handle the weight of a structure 12 without letting the upper platform assembly 20 sag significantly. In one embodiment of the invention, the angle of arm element 80 and the upper platform assembly are positioned and configured to maintain an angle Θ₁ that is slightly over 90° in order to address possible sagging of the upper platform assembly 20 under the weight of the structure 12. For example, an angle Θ₁ in the range of 91°-94° might be used in order for the lift 10 and the upper platform assembly 20 to maintain generally a horizontal disposition with respect to the ground surface when under the load of a tent or other structure 12.

For a similar purpose, one embodiment of the invention may configure the vertical support 18 to extend at an angle Θ₂ to the lower platform assembly 16 (sitting on a ground or floor surface) that exceeds 90° in order to address the weight of the load that is being lifted. For example, the lift may be configured so that the vertical support 18 extends at an angle Θ₂ to the lower platform assembly 16 in the range of 91°-94° in order for the lift 10 and the upper platform assembly 20 to maintain generally a horizontal disposition with respect to the ground/floor surface when under the load of a tent or other structure 12. Therefore, one or more angles Θ₁, Θ2 might be used to ensure that under load the lift 10 maintains the tent or other structure in a generally horizontal disposition when it is being lifted, lowered and moved or stored with the lift.

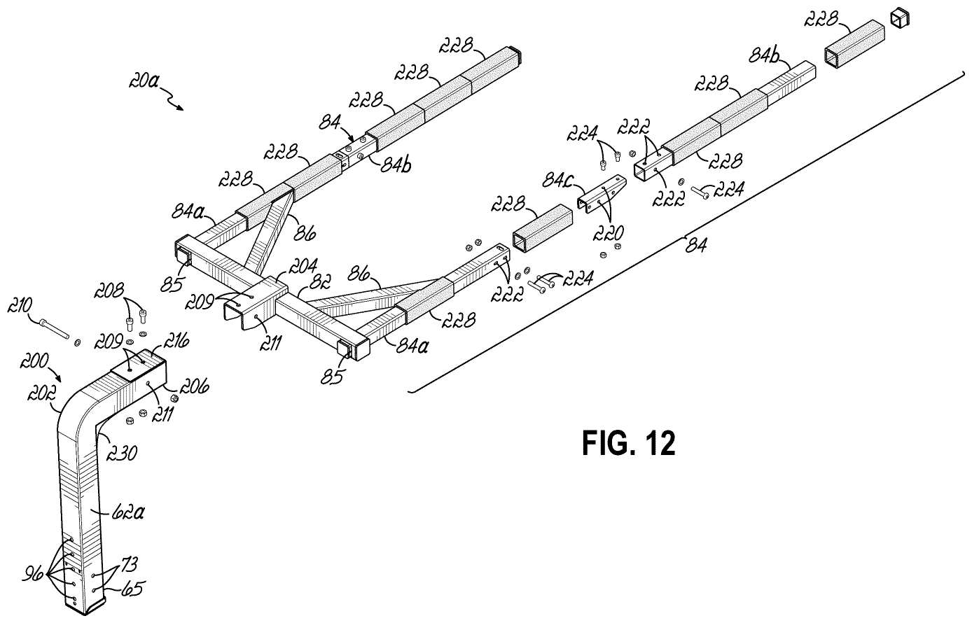

In the upper platform assembly, as seen in FIG. 2, the arm element 80 couples with a horizontal cross beam 82, generally in the middle of the cross beam as shown in the Figures. For example, the cross beam 82 might be bolted to the end of the arm element 80. To that end, an element (not shown) extending from the cross beam 82 might be inserted into the arm element 80, and then secured with one or more bolts or fasteners 81, as shown in FIG. 12 discussed herein. Extending forwardly from each end of the horizontal cross beam 82 are horizontal support arms 84. The horizontal support arms are configured to underlie and support a structure 12, such as a tent, when the lift is in position as shown in FIG. 1. The horizontal support arms may be unitary arms, as shown in FIGS. 2-4 or might have multiple sections as shown in other embodiments disclosed herein, such as in FIGS. 8-10. Multiple arm sections may be appropriately secured together to form the arms 84. The various embodiments as disclosed herein and the various lower platform assemblies may be used with various different upper platform assemblies with alternative embodiments. The horizontal support arms 84 may be secured in various different ways to the cross beam 82 such as by welding or fasteners/bolts.

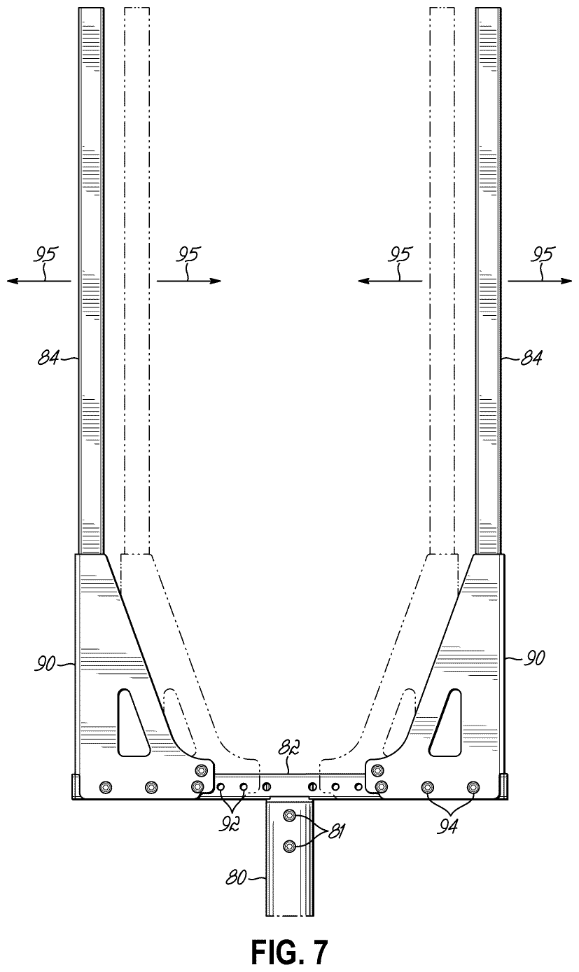

In accordance with one embodiment of the invention, the horizontal support arms 84 might be adjustable with respect to the cross beam 82 to change the width of the upper platform assembly 20. In the embodiment shown in FIG. 2, for example, horizontal support arms 84 are coupled with angle brackets 90. For example, the support arms 84 might be secured with appropriate welding or fasteners to rigidly extend from the angle brackets 90. The brackets 90 include a number of fasteners 94 that extend through respective holes in the brackets 90. The cross beam includes a number of fastener openings 92 along its length. Referring to FIG. 7, the angle brackets 90 might be mounted to different sets of the fastener openings 92 along the length of the cross beam. In that way, as shown by the arrows 95, the horizontal distance between the support arms 84 may be adjusted to adjust the overall width of the upper platform assembly 20. The brackets are angular, such as triangular in the illustrated embodiment, and span the between the cross beam 82 and the horizontal support arms 84 for greater rigidity and strength and to ensure that the proper angle is maintained between the cross beam 82 and the horizontal support arms 84.

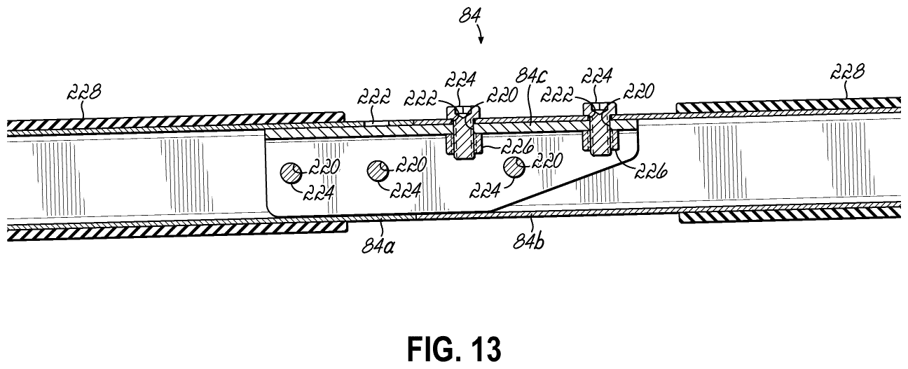

FIGS. 8-10 illustrate another embodiment of the lift 10a of the invention that implements some different elements in the overall lift. Like reference numerals are used to indicate similar elements and components as those shown in the embodiment of FIGS. 2-4. For example, as illustrated in FIG. 8, the upper platform assembly 20a that is implemented has some different features. In one regard, the horizontal support arms 84 are composed of multiple sections 84a, 84b that are fit together in a suitable fashion such as is illustrated and explained with respect to FIG. 13. The proximal ends of the horizontal support arms 84 are tubular and may extend through appropriate openings 85 formed in the cross beam 82 as shown in FIG. 8. They might be secured with appropriate welding or fasteners to rigidly extend from the cross beam 82. In such an embodiment, angle elements 86 might be fixed between the cross beam 82 and the horizontal support arms 84, such as by welding, for greater rigidity and strength and to ensure that the proper angle is maintained between the cross beam 82 and the horizontal support arms 84. The angle between the cross beam 82 and the horizontal support arms 84 is shown to be generally a right angle so that the arms extend perpendicularly, but other angles might be used.

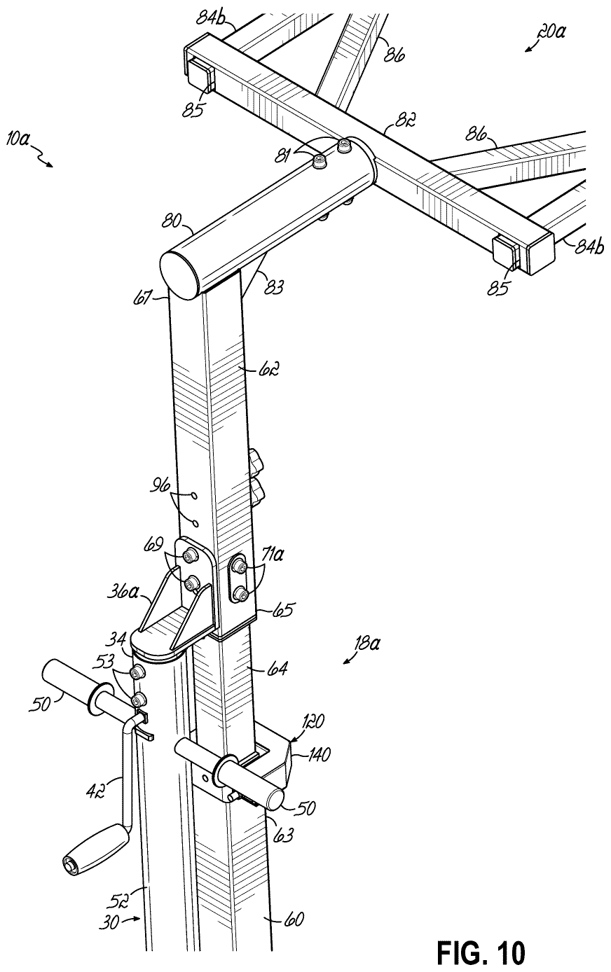

In accordance with another feature of the embodiment of FIGS. 8-10, the vertical support 18a has adjustability in the height of its interface with the linear actuator 30. That is, the adjustable vertical support includes a plurality of mount positions for coupling the linear actuator to the adjustable vertical support. Referring to FIG. 10, the mounting bracket 36a that is fixed to the upper end 34 of the linear actuator 30 is bolted to the outer tube 62 of the vertical support 18a through a series of selectable holes in the outer tube. Specifically, the outer tube 62 incorporates a plurality of bolt holes 96 through which the bolts 69 may extend to secure the linear actuator 30 with the vertical support. The end of the linear actuator and bracket 36a may be moved vertically along the length of the outer tube 62 to raise and lower the height of the outer tube and the upper platform assembly 20a with respect to the lower platform assembly 16 and ground or floor surface. In that way, a discrete or fixed height adjustment to the upper platform assembly 20a may be added to the lift to supplement the continuous adjustment and action of the linear actuator. For example, if the bracket 36a is coupled to uppermost sets of bolt holes as shown in FIG. 8, the upper platform assembly 20a will have a certain height with respect to the ground level even when the linear actuator, and therefore bracket 36a, are at the highest adjusted position. However, by moving bracket 36a to engagement with the lowermost set of holes, the upper platform assembly 20a will have an increased or greater height with respect to the ground level (based upon moving the second outer tube 62 higher) when the linear actuator, and therefore bracket 36a, are at that same highest adjusted position. In that way, the bracket 36a may be used with the linear actuator to provide discrete adjustments to the lowest and highest positions for the upper platform assembly 20a when it is raised and lowered.

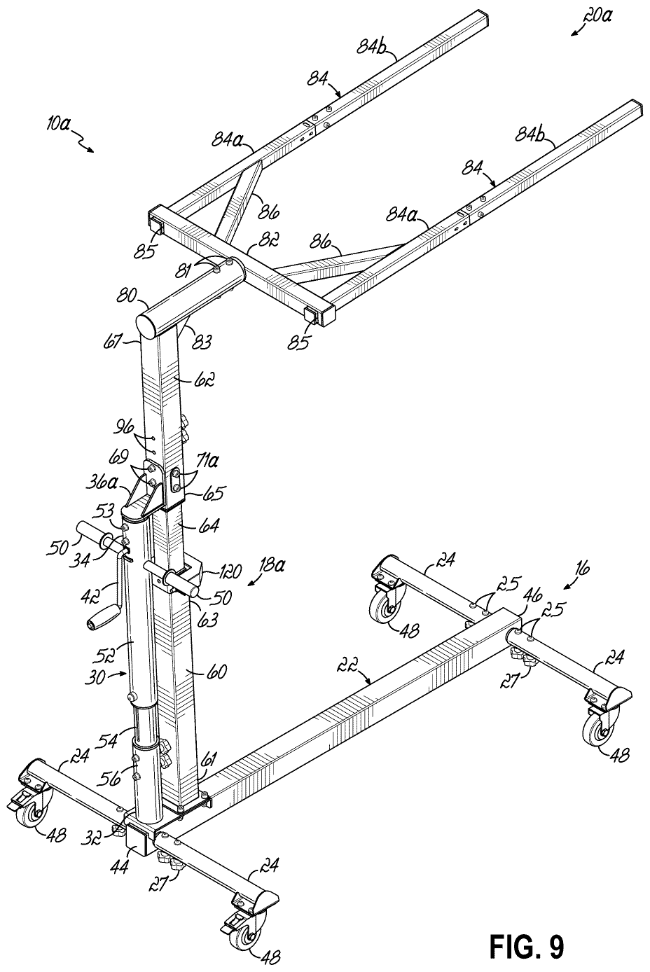

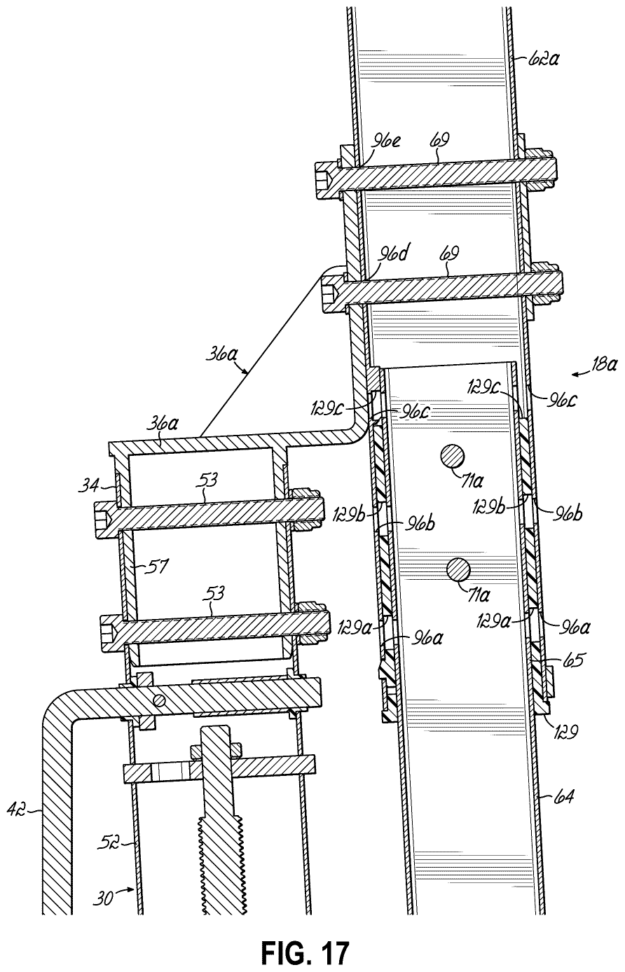

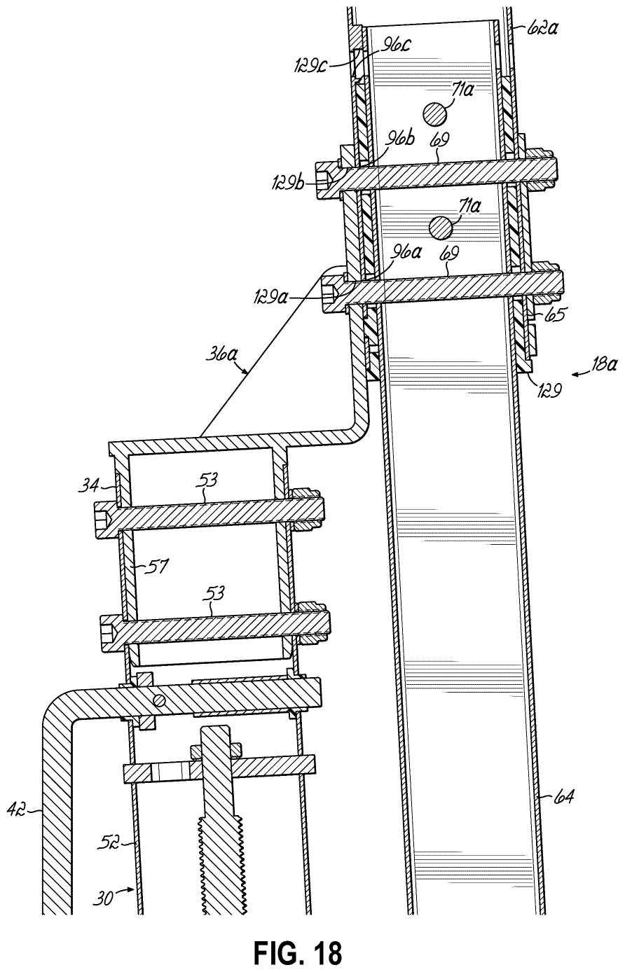

FIGS. 17 and 18 further illustrate the height adjustment features and the plurality of mount positions for coupling the linear actuator second end to the adjustable vertical support as illustrated in the embodiment of FIGS. 8-9. Specifically, as shown in FIG. 17, various openings or bolt holes 96 a-e are illustrated in the second outer tube 62a. The bracket 36a, may be coupled to outer actuator tube 52 with bolts 53 at different positions along the second outer tube for providing gross adjustments to the movement of the upper platform with the actuator. Specifically, the bracket 36a has an insert base section 57 that couples with or is inserted into the top of the outer actuator tube 52. The bolts 53 extend through appropriate aligned openings in the base section 57 and in the outer actuator tube 52 to secure the bracket with the outer actuator tube 52 so the bracket 36a moves up and down with the outer actuator tube 52 of linear actuator 30.

In FIG. 17, the bracket 36a is secured with the second outer tube through the uppermost plurality of bolt holes 96d, 96e in the second outer tube 62a. That is the bolts 69 extend through holes or openings in the bracket 36a that align with the holes 96d, 96e and couple the linear actuator and bracket 36a at that uppermost position along the second outer tube 62. Accordingly, for a certain extension length of the linear actuator, the lift will raise the upper platform assembly 20a a certain distance above the ground. In an alternative configuration, as shown in FIG. 18, the bracket 36a is secured with the second outer tube through one or more lower holes, such as the lowermost plurality of bolt holes 96a, 96b. That is the bolts 69 extend through the aligned bracket holes and the holes 96a, 96b and couple the linear actuator and bracket 36a at that lowermost position along the second outer tube 62. This, in effect, raises the upper platform assembly 20 a certain initial distance above the ground for the same extension length of the linear actuator 30. That is, as shown in FIG. 18, the second outer tube 62 sits higher on the inner tube 64, thus raising the upper platform assembly 20 even with the same height of bracket 36a and the same extension length of the linear actuator. Therefore, depending on where the bracket and linear actuator are coupled to the adjustable vertical support 18, different height ranges from the lowest height to the highest height may be achieved for the lift with the same linear actuator.

In one embodiment of the invention, the holes 96 may be positioned on the second outer tube 62 to give a discreet height adjustments as desired to provide gross height adjustments for the lift before the actuator provides a more continuous height adjustment as it is actuated. There may be an appropriate number of holes along the length of the second outer tube 62 for facilitating various different positions for such height adjustments. This allows a user to tailor a lift to their particular vehicle situation and height to get the desired adjustability. It also allows a more proper positioning of the lowered and raised positions of the lift for the vehicle and for the particular object being lifted without requiring as large of a motion of the actuator. The distance between the various holes 96a-e might be selected for providing the gross adjustments. For example, gross adjustments of approximately 1-3 inches might be provided for the lift by separating the holes from each other in that range and then coupling the bracket 36a, and effectively the actuator, with the second outer tube 62a through the pairs of the plurality of selected holes 96a-e.

As discussed herein, the second outer tube 62a and the upper end of the inner tube 64 may be fixed together, such as with appropriate bolts or other fasteners. Specifically as shown in FIG. 12, the second outer tube 62a includes openings 73 that will receive fasteners 71a that extend therethrough for coupling the second outer tube 62a and the upper end of the inner tube 64. As will be appreciated, the inner tube 64 will include similar aligned openings that align with the openings 73 for the fasteners 71a to engage. In that way, the second outer tube 62 and inner tube 64 move together in a telescoping fashion with respect to the outer tube 60. As shown in FIGS. 17 and 18, the bushing 129 will be coupled between the second outer tube 62a and the upper end of the inner tube 64 and so will also have appropriate openings therethrough for receiving the fasteners 71a. Also, as shown in FIGS. 17 and 18, the bushing 129 will include openings 129a, b, c that are in alignment with the various openings in outer tube 62a and inner tube 64 for the bolts 69.

Lift 10 may be moved toward a vehicle 14. Lower platform assembly 16 may be of any size which is configured to be located relative to vehicle so as to locate the upper platform assembly 20 for underlying structure 12 in a position to engage and lift it from vehicle. In the embodiment depicted in FIGS. 1-9, lower platform assembly 16 is configured to fit under a vehicle in-between the axels or wheels of the vehicle. Handles may be used to steer the lift into a position at which lower platform assembly is disposed under vehicle 14 in-between the front and rear wheels (See FIG. 1). In the embodiment depicted, linear actuator may be actuated by the hand crank, which may be rotated to cause the lift to move from a first position at which the tops of support arms are low enough to clear the underside of the structure to a second position at which the support arms have lifted the structure off of vehicle 14 a sufficient distance to withdraw the lift and structure away from the vehicle. The first position may be, but is not limited to, the fully lowered position and the second position may be, but is not limited to, the fully extended position.

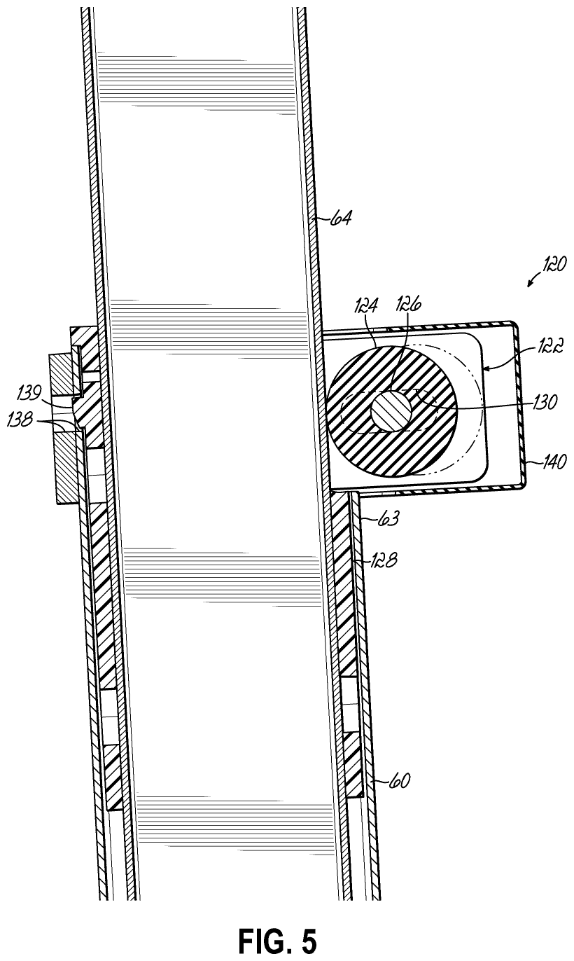

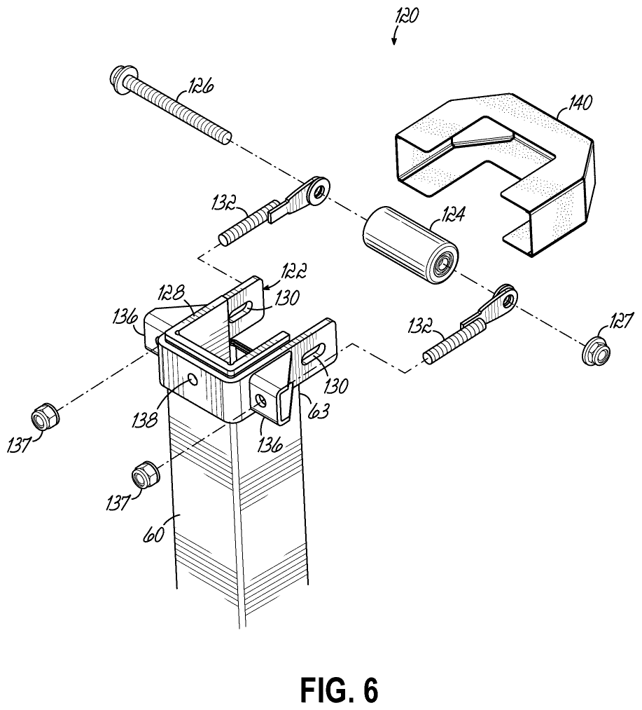

To allow smooth telescoping of the inner and outer tubes of the vertical support 18 as well as to provide strengthening at the juncture where the first outer tube 60 and the inner tube 64 telescope, one embodiment of the invention uses a support bracket assembly 120 is used as illustrated in FIGS. 5 and 6. The assembly 120 includes a bracket element 122 that surrounds the upper end 63 of the first outer tube 60. As shown in FIG. 5, an end of the inner tube 64, such as a lower end of the inner tube, telescopes into the first outer tube 60 through a bushing 128. As discussed further herein, the other end of the inner tube 64, such as an upper end, telescopes into the first outer tube 60 through a bushing 129 as shown in FIG. 17, for example. The bracket element 122 secures a roller 124 therein through an axle bolt 126 that fits into slotted openings 130 in the bracket. The axle bolt is secured with an appropriate nut 127. The upper end 63 of the first outer tube is configured to allow the roller to contact the inner tube 64 as shown in FIG. 5.

The roller and axle bolt are also coupled to adjustment bolts 132 that receive the axle bolt 126 at one end and pass through side brackets 136 to be secured with appropriate nuts 137. The nuts 137 may be tightened or loosened to move the roller and axle bolt in the slotted openings 130 toward or away from the inner tube 64 to ensure robust coupling at the juncture and to ensure that the telescoping function is smooth and tight when the tubes telescope and move with respect to each other. A cover 140 may be mounted over the roller and other components at the bracket 122. Referring to FIG. 5, the bracket 122 and inner tube 64 include aligned openings 138 that interface with a similarly aligned protrusion 139 of the bushing 128 to keep the bushing aligned with the bracket 122 and inner tube 64 at the juncture with the support bracket assembly 120.

FIG. 11 illustrates another alternative embodiment of a lift 10b in accordance with features of the invention. The lift 10b implements a different interface section 200 between the vertical support 18a and the upper platform assembly 20a from that of the embodiment of FIGS. 8-10. In FIG. 11, like reference numerals are used to indicate similar elements and components as those shown in the embodiment of FIGS. 8-10. In accordance with one feature, rather than an arm element 80 secured to the second outer tube 62, the second outer tube 62a alternatively is formed to make a generally right angle where it interfaces with the upper platform assembly 20a. Referring to FIG. 11, the second outer tube 62a forms an elbow section 202 so that the second outer tube includes a section that extends vertically upwardly and then a section that extends at an angle to the vertical section to engage the upper platform assembly. In one embodiment, the section of the outer tube 62a that extends at an angle to the vertical section will extend at generally a 90° angle to extend generally horizontally and engage the upper platform assembly 20a. As discussed herein, the horizontal section angle to the vertical section of the elbow section may actually exceed 90° so that the platform assembly 20 a will he generally horizontal when it is under load. The upper platform assembly 20a can interface with the elbow section 202, similarly to the engagement with the arm element illustrated in FIG. 8.

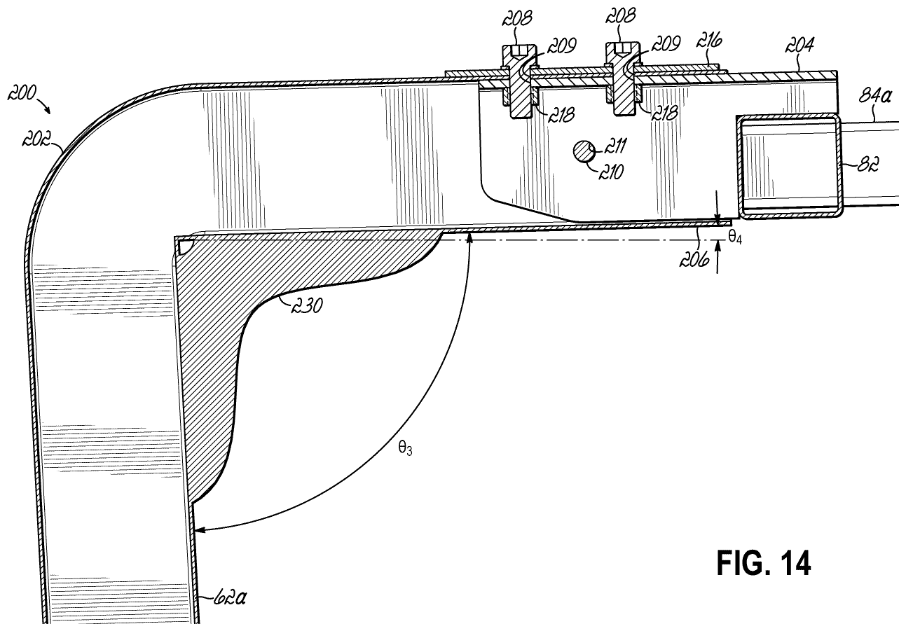

For example, turning to FIGS. 12 and 14, in the upper platform assembly the elbow section 202 couples with a horizontal cross beam 82, generally in the middle of the cross beam as shown in the Figures. For example, the cross beam 82 might be bolted to the end 206 of the elbow section. To that end, a telescoping element 204 extending from the cross beam 82 might be inserted into the end 206 of the elbow section 202. The telescoping element 204 includes holes 209, 211 that may be aligned appropriately with similar holes 209, 211 in the elbow section 202. The telescoping element and elbow section are then secured together with one or more bolts or fasteners 208, 210, as shown in FIG. 12. For example, referring to FIG. 14, one or more bolts 208 may extend into openings 209 from above and extend horizontally, while one or more bolts 211 may extend in from the side of the elbow section 202 in a vertical orientation. The bolts may be secured by appropriate nuts or may screw into threaded bosses 218 in the telescoping element 204 as shown in FIG. 14. In that way, the upper platform assembly 20a is secured to the vertical support 18a to be raised and lowered therewith. In one embodiment of the invention, a strength plate 216 may be implemented along the top surface of the end 206 of the elbow section 202 as shown in FIG. 14. The strength plate has appropriate holes and may be held in position with bolts 208 as shown. Alternatively, the plate 218 may be welded to the top surface of the end 206 of the elbow section 202. The strength plate 218 provides additional support and strength to the juncture where the upper platform assembly 20a meets the elbow section 202.

The horizontal cross beam 82 may be welded or otherwise secured with the telescoping element 204 as shown in FIG. 14. Extending forwardly from each end of the horizontal cross beam 82 are horizontal support arms 84 as discussed herein which are configured to underlie and support a structure 12 when the lift is in position as shown in FIG. 1. The proximal ends of the horizontal support arms 84 are tubular and may extend through appropriate openings 85 formed in the cross beam 82 as shown in FIG. 8. They might be secured with appropriate welding or fasteners to rigidly extend from the cross beam 82. The horizontal support arms of the embodiment in FIGS. 11-12 have multiple sections as shown. Multiple arm sections 84a, 84b are appropriately secured together to form the arms 84. Referring to FIGS. 12 and 13, the arm sections 84a, 84b may be coupled with a telescoping insert element 84c that fits into abutting ends of the arm sections 84a, 84b. As discussed herein, angle elements 86 might be fixed between the cross beam 82 and the horizontal support arms 84, such as by welding, for greater rigidity and strength and to ensure that the proper angle is maintained between the cross beam 82 and the horizontal support arms 84. The angle between the cross beam 82 and the horizontal support arms 84 is shown to be generally a right angle so that the arms extend perpendicularly, but other angles might be used.

Referring to FIG. 13, the insert element 84c fits into abutting ends of the arm sections and a portion of the insert element is contained in each arm section. The insert element 84c has holes 220 that align with similar holes 222 in each end of the arm sections 84a, 84b. The aligned holes 220, 222 are configured to receive bolts 224 or other fasteners to hold together the arm sections into a unitary horizontal support arm 84. Appropriate nuts may be used, or the insert element 84c may incorporate threaded bosses 226 in the telescoping insert element 84c as shown in FIG. 13.

In accordance with another feature of the embodiment of FIG. 11, tubular rubber elements 228 may be used on the horizontal support arms 84. The rubber elements 228 are configured and sized to sit on the outside of the horizontal support arms 84 as shown, such as to cushion a lifted element from the metal forming the horizontal support arms 84.

Referring to FIG. 14, in one embodiment of the invention, an angled support bracket 230 might be secured, such as by welding. Of course, the bracket might not be used as well. The angled support bracket 230 further strengthens the juncture at the angle between those elements to handle the weight of a structure 12 without letting the upper platform assembly 20a sag significantly. In one embodiment of the invention, the angle of the elbow section 202 of the second outer tube 62a is configured to maintain an angle Θ₃ that slightly exceeds 90° in order to address possible sagging of the upper platform assembly 20a under the load weight of the structure 12, as shown by the sag angle Θ₄. For example, an angle Θ₃ in the range of 91°-94° might be used in order for the lift 10 and the upper platform assembly 20 a to maintain generally a horizontal disposition with respect to the ground/floor surface when under the load of a tent or other structure 12 and creates some sag as shown in Θ₄.

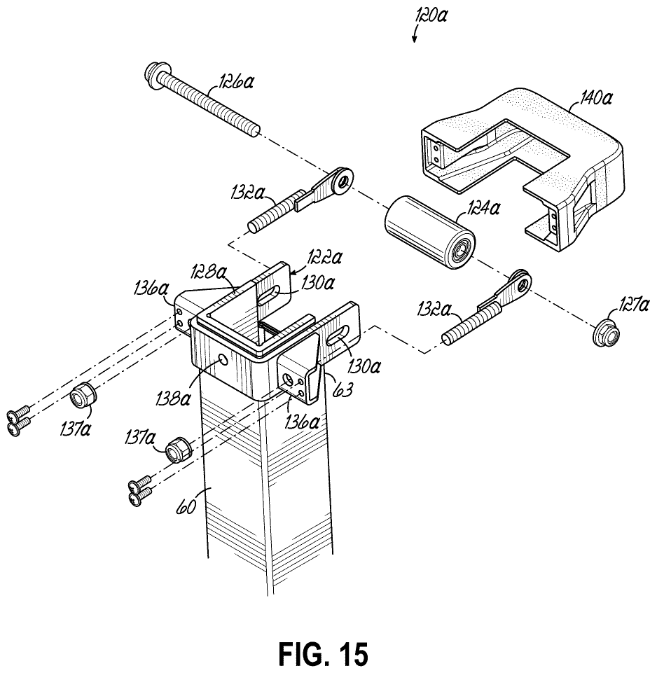

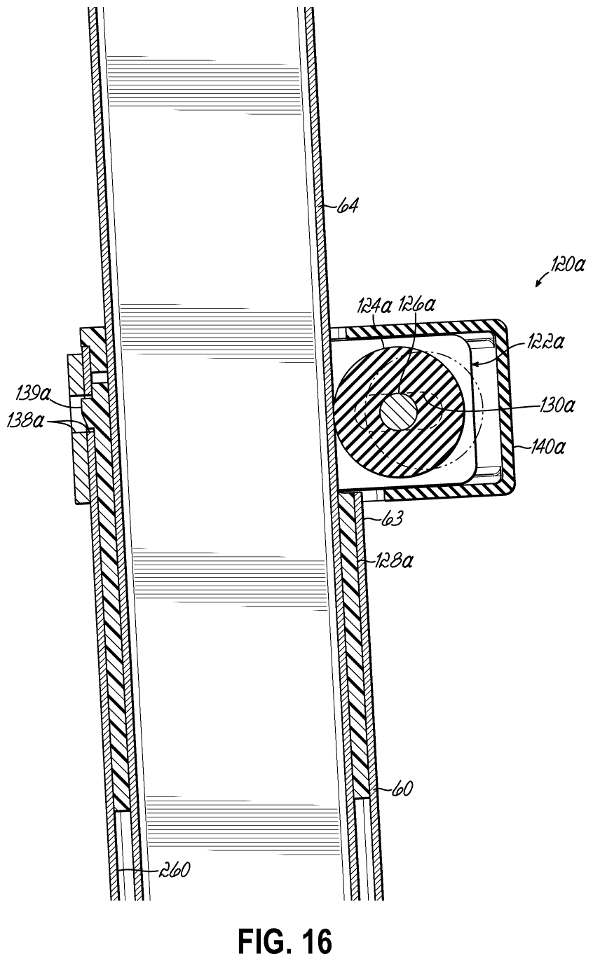

In the embodiment shown in FIG. 11, to allow smooth telescoping of the inner and outer tubes of the vertical support 18 as well as to provide strengthening at the juncture where the first outer tube 60 and the inner tube 64 telescope, a support bracket assembly 120a is used as shown in FIGS. 15 and 16. The support bracket assembly 120a is similar to the bracket assembly 120 of FIGS. 5 and 6 and operates similarly. The assembly 120a includes a bracket element 122a that is positioned to surround the upper end 63 of the first outer tube 60. As shown in FIG. 15, an end of the inner tube 64 telescopes into the first outer tube 60 through a bushing 128a. The bracket element 122a secures a roller 124a therein through an axle bolt 126a that fits into slotted openings 130a in the bracket. The roller 124a is secured with the first outer tube and engages an outer surface of the inner tube to roll against the inner tube during telescoping of the vertical support. The axle bolt is secured with an appropriate nut 127a. The upper end 63 of the first outer tube is configured, such as with a cut out section or area, to allow the roller to contact the outer surface of the inner tube 64 as shown in FIGS. 15 and 16.

The roller and axle bolt are also coupled to adjustment bolts 132a that receive the axle bolt 126a at one end and pass through side brackets 136a to be secured with appropriate nuts 137a. The nuts 137a may be tightened or loosened to move the roller and axle bolt in the slotted openings 130a toward or away from the inner tube 64 to ensure robust coupling at the juncture and to ensure that the telescoping function is smooth and tight when the inner tube telescopes and move with respect to the first outer tube. A cover 140a may be mounted over the roller and other components at the bracket 122a. Referring to FIG. 15, the bracket 122a and inner tube 64 include aligned openings 138a that interface with a similarly aligned protrusion 139a of the bushing 128 a to keep the bushing aligned with the bracket 122a and inner tube 64 at the juncture with the support bracket assembly 120a.

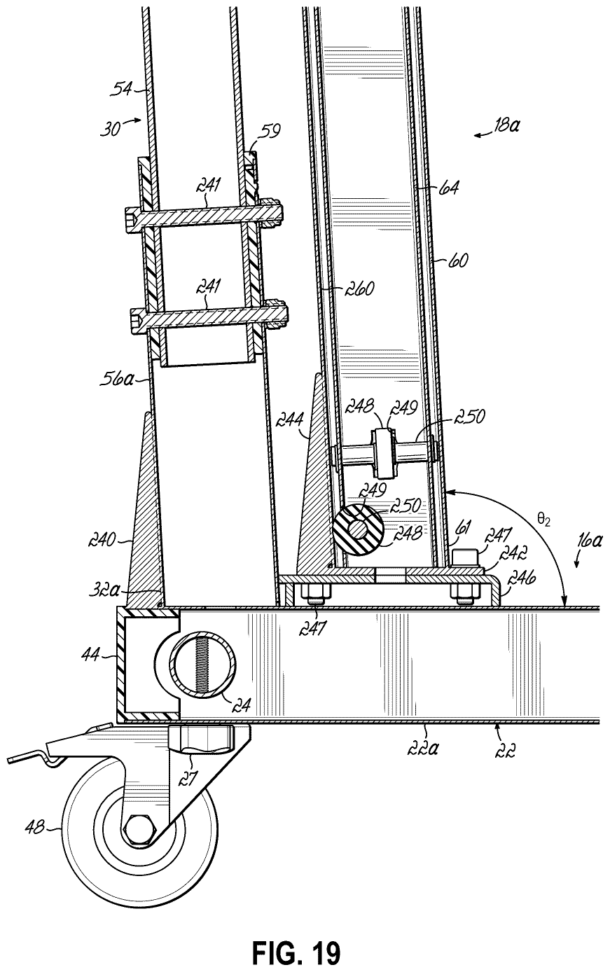

FIG. 19 illustrates a side cross-sectional view of the lift 10b of the embodiment of FIG. 11 at the base where the dual vertical support formed by the adjustable vertical support 18a and the parallel linear actuator 30 interface to the lower platform assembly 16a. The linear actuator 30 is mounted appropriately to the lift. For example, the base end 32a or lower end of tubular base element 56a may be welded as shown to the lower platform assembly 16a and to main support section 22a. A strengthening fin 240 may also be welded to the support section and tubular base element 56a for strengthening the juncture of the linear actuator and the main support. The inner actuator tube 54 is coupled with the tubular base element 56a and fits inside thereof. The inner actuator tube 54 is secured with the tubular base element 56a with appropriate bolts 241 or other fasteners. A bushing 59 is positioned between the inner actuator tube 54 and the tubular base element 56a for a secure fit and anchoring of the linear actuator.

The first outer tube 60 of the adjustable vertical support 18a includes a flange 242 that has a strengthening fin 244 may also be welded to the flange 242 for strengthening the juncture of the vertical support 18a and the main support. For mounting, a plate 246 is welded to main support section 22a. The flange 242 is then fixed to the plate 246, such as with bolts 247. The flange 242 is configure and secured to the first outer tube to maintain the vertical support at a desired angle Θ₂ to the lower platform assembly that exceeds 90° and can be in the range of 91°-94° in order for the lift 10 and the upper platform assembly 20a to maintain generally a horizontal disposition with respect to the ground/floor surface when under the load of a tent or other structure 12. The inner tube 64, which is fixed to the second outer tube, is configured to slide and telescope in the first outer tube 60 when the lift is raised and lowered. To assist in a smooth telescoping motion of the inner tube 64 and the first outer tube 60, one or more rollers 248 might be incorporated into the lift. The rollers 248 in the illustrated embodiment, are mounted for rotating inside the inner tube 64. The rollers 248 are mounted on appropriate axles 250 that are secured inside the inner tube to sides of the inner tube 64. The rollers are configured to engage an inner surface of the first outer tube 60. To that end, the rollers 248 are positioned to extend through one or more respective openings 249 in the side walls of the inner tube to engage and press against an inside surface 260 of the outer tube 60. The rollers are shown positioned at a lower end of the inner tube in the figures but may be positioned elsewhere. When the inner tube is raised or telescoped, the rollers roll along the outer tube inside surface 260 and ensure a straight and smooth telescoping motion along the distance of travel. The rollers prevent the lower end of the inner tube from rattling in the outer tube 60 and in combination with the roller 124a positioned at an upper end of the outer tube that also contacts and influences the travel of the inner tube, ensures a smooth and noise free telescoping motion. In the embodiment illustrated in FIG. 19, two rollers 248 are shown implemented but multiple such rollers may be used in each position as shown. In accordance with one feature of the invention, the axles of the rollers are positioned to be perpendicular to each other so as to engage multiple adjacent inside surfaces 260 of the outer tube 60. For example, one roller shown engages an inner surface of the first outer tube that faces the actuator. Another roller (not shown) might be similarly situated to engage an inner surface 260 on the opposite side. Similarly, one or more rollers 248 may be positioned as shown above or below and oriented to engage side inner surfaces of the first outer tube 60. In that way, side to side and forward and/or rearward movements of the inner tube 64 of the inner tube are addressed to provide smooth telescoping.

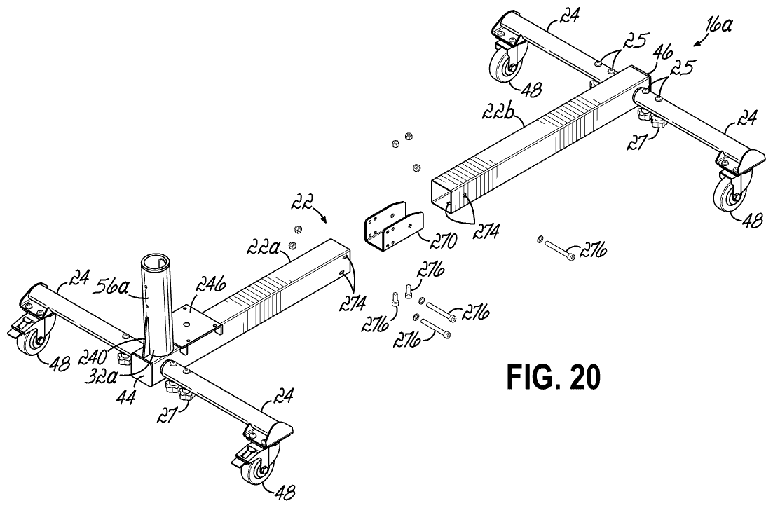

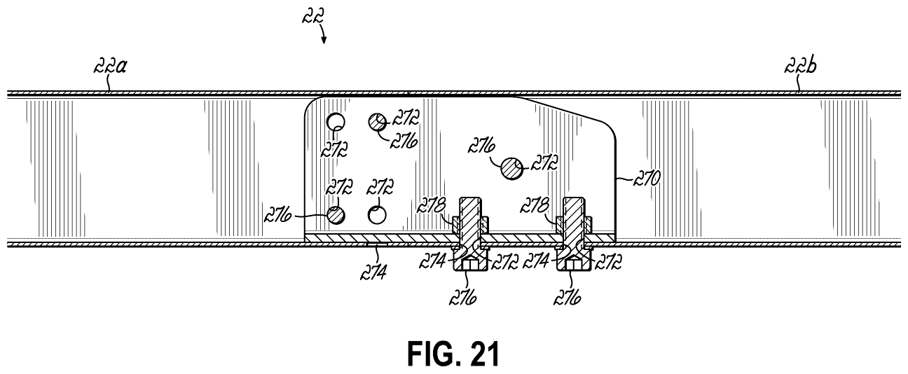

FIG. 20 illustrates an exploded view of the lower platform assembly and the main support and the multiple sections 22a, 22b that are fixed together to form the main support 22 in accordance with an embodiment of the invention. The main support has multiple sections as shown. Sections 22a, 22b are appropriately secured together to form the main support 22. Referring to FIGS. 20 and 21, the sections 22a, 22b may be coupled with a telescoping insert element 270 that fits into abutting ends of the sections 22a, 22b. Referring to FIG. 21, the insert element 270 fits into abutting ends of the sections 22a, 22b and a portion of the insert element is contained in each arm section. The insert element 270 has holes 272 that align with similar holes 274 in each end of the sections 22a, 22b. The aligned holes 272, 274 are configured to receive bolts 276 or other fasteners to hold together the arm sections into a unitary horizontal support arm 84. Appropriate nuts may be used, or the insert element 270 may incorporate threaded bosses 278 in the telescoping insert element 270 as shown in FIG. 21. When the sections 22a, 22b and insert element 270 are secured together, a unitary main support as shown in FIG. 11 is presented.

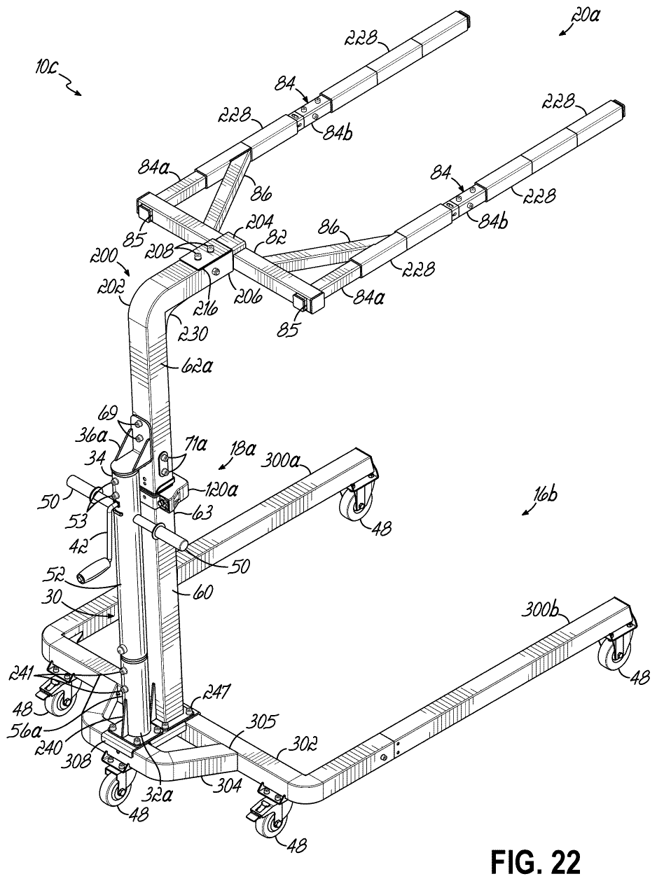

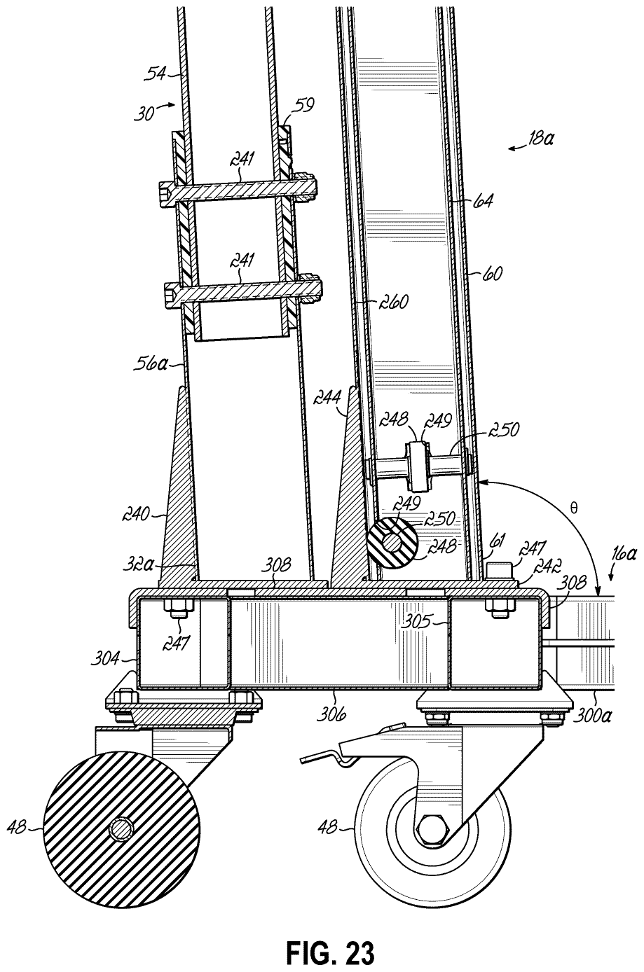

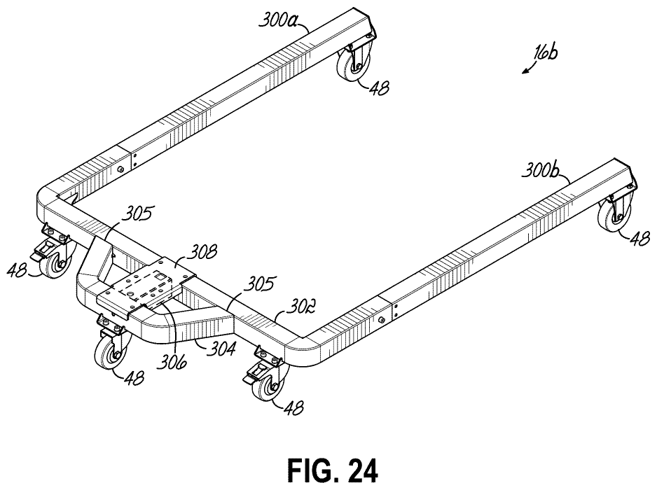

FIGS. 22-24 illustrate an alternative embodiment of the invention that might be used with truck. Specifically, the lift 10c implements features of other lifts described herein and also incorporates additional features to adjust to configurations of alternative vehicles. For example, the lift 10c, as shown in FIG. 22 has a upper platform assembly 20a, vertical support 18a and a linear actuator 30 that are all similar to the embodiment shown in FIG. 11. Accordingly, similar reference numbers are utilized in FIG. 22. However, to accommodate the fact that lifting a structure onto a truck (not shown) may include lifting or positioning over the bed of the truck, the tires of the vehicle may come into play. To that end, the lift 10c has a lower platform assembly 16b that has a U-shaped construction with two legs 300a and 300b that are connected by a base member 302 to form the lower platform assembly for supporting the vertical support 18a and a linear actuator 30. For further stability and mounting of the vertical support 18a and a linear actuator 30, a spanning element 304 spans rearwardly of the base member 302 as shown in FIGS. 22 and 24. The spanning element extends also in a U-shape and attaches to the base member 302 at two points 305, such as by welding. A short linear member 306 spans between the base member and the spanning element as shown in FIGS. 23 and 24 and is coupled appropriately, such as by welding. The linear member 306 provides a third support element with the base member and the spanning element in order to secure and support the vertical support 18a and a linear actuator 30 as shown. To that end, a mounting plate 308 might be secured as shown in FIG. 24 to the linear member 306 and the base member 302 and the spanning element 304, such as with fasteners or welding. The mounting plate then receives the flange 242/strengthening fin 244 of the vertical support 18a, which may be secured by welding or one or more fasteners 247 as shown in FIG. 23. The mounting plate also receives the linear actuator 30, and more specifically, receives the flange 243 and strengthening fin 240 at the in order to secure the linear actuator 30 at the base end of lower end 32a of the actuator. Again, the flange 243 may be secured by welding or one or more fasteners 247 as shown in FIG. 23. Wheel assemblies 48, may be coupled to the ends of the two legs 300a and 300b and the ends of the base member 302 as shown. For further stability, a wheel assembly my also be used with the spanning element 304 rearwardly of the base member 302 to provide various support points in the lift for rolling and moving the lift and its payload, such as a tent. Referring to FIG. 22, in one embodiment, the two legs 300a and 300b might be in multiple pieces or sections and coupled together with a telescoping insert element 270 and other fasteners and elements as used in the embodiment shown in FIGS. 20-21.

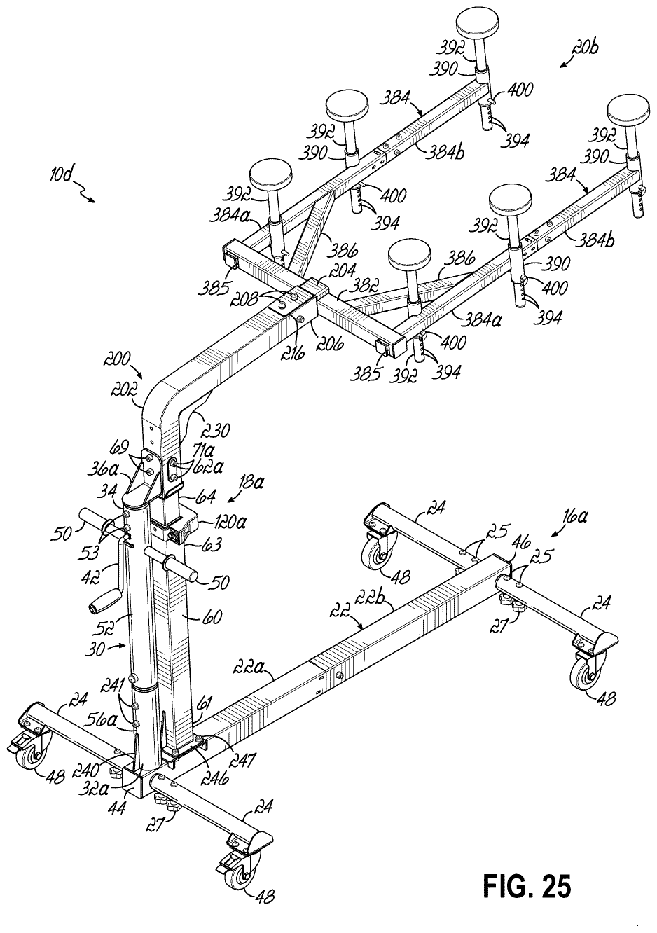

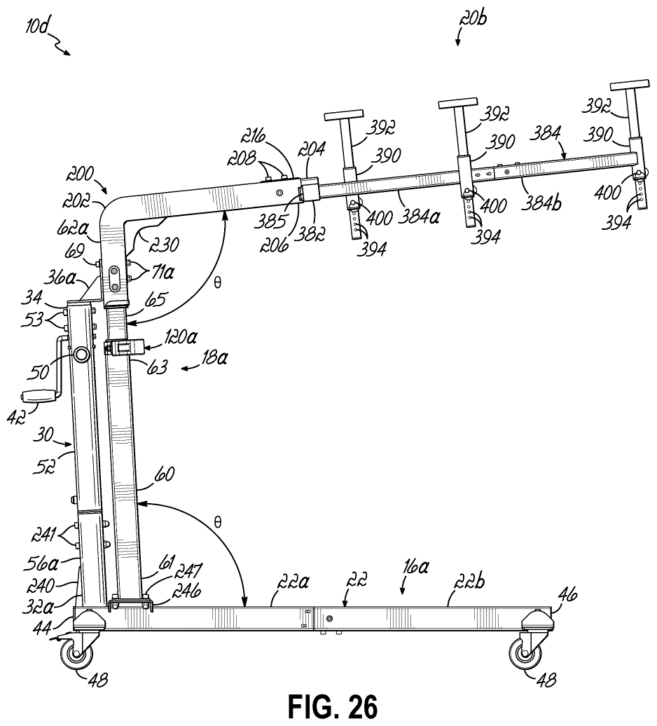

FIGS. 25 and 26 illustrate another embodiment of the invention that might be used for lifting other items, such as a truck cap or bed top. Specifically, the lift 10d might be used for removing and/or installing a truck cap onto the bed of a truck. To that end, the upper platform assembly might be configured for engaging a truck cap (not shown). In accordance with the invention, the lift 10d, as shown in FIGS. 25-26 has a lower platform assembly 16a, vertical support 18a and a linear actuator 30 that may all be similar to the embodiment shown in FIG. 11 or other embodiments as disclosed herein. Accordingly, similar reference numbers are utilized in FIGS. 25-26 for similar elements. The lift 10d of FIG. 25 has a different upper platform assembly 20b as illustrated. Specifically, the upper platform assembly 20b is configured to underlie a truck cap.

To that end, the lift 10d implements an interface section 200 between the vertical support 18a and the upper platform assembly 20b that is similar to the interface section 200 used in the embodiment of FIGS. 11-14. Accordingly in FIGS. 25-26, like reference numerals are used to indicate similar elements and components as those shown in the embodiment of FIGS. 11-14. That is, referring to FIG. 25, the second outer tube 62a forms an elbow section 202 that extends upwardly and then at an angle to engage the upper platform assembly. As discussed, the angle may be approximately a 90° angle to engage the upper platform assembly 20 b and generally might exceed 90° to allow for sag of the assembly 20 a under load. The upper platform assembly elbow section 202 couples with a horizontal cross beam 382, generally in the middle of the cross beam as shown in the Figures. For example, the cross beam 382 might be bolted to the end 206 of the elbow section. To that end, as is shown in FIGS. 12-14, a telescoping element 204 may extend from the cross beam 382 and might be inserted into the end 206 of the elbow section 202 and secured as described herein raised and lowered therewith. A strength plate 216 may be implemented along the top surface of the end 206 of the elbow section 202 as shown in FIG. 25 and secured as described herein. In the embodiment of FIGS. 25-26, the elbow section 202 may be dimensioned to be shorter in vertical length but longer in horizontal length than the elbow section 202 of FIG. 11 because, a truck cap may need to be engaged differently when it is being removed and may not need to be lifted as high as, for example, a tent. As will be understood, the present invention is not limited to certain vertical dimensions or horizontal dimensions and the various lengths of the elements used in the lower platform assembly 16a, vertical support 18a, a linear actuator 30 and upper platform assembly 20b my be sized and configured as needed for the application without deviation from the invention.

Extending forwardly from each end of the horizontal cross beam 382 are horizontal support arms 384 as discussed herein which are configured to underlie and support a structure when the lift is in position. The proximal ends of the horizontal support arms 384 are tubular and may extend through appropriate openings 385 formed in the cross beam 382 as shown in FIG. 25. They might be secured with appropriate welding or fasteners to rigidly extend from the cross beam 382. The horizontal support arms of the embodiment in FIGS. 25-26 have multiple sections as shown. Multiple arm sections 384a, 384b are appropriately secured together to form the arms 384. For example, they can be secured together similarly those arm sections shown in FIGS. 12 and 13, wherein the arm sections 384a, 384b may be coupled with a telescoping insert element that fits into abutting ends of the arm sections 384a, 384b. As discussed herein, angle elements 386 might be fixed between the cross beam 382 and the horizontal support arms 384, such as by welding, for greater rigidity and strength and to ensure that the proper angle is maintained between the cross beam 382 and the horizontal support arms 384 similar to FIGS. 12-13 described herein.

Coupled to each of the horizontal support arms 384 are a plurality of support carriers 390 which receive and thereby locate a plurality of respective supports 392. The supports 392 may be vertically adjustable with respect to the lift 10d and upper platform assembly 20b to allow conformation of the tops of the supports 392 to the engaged surface of a load, such of a truck cap or hard top, to maintain the load in a desired orientation, such as horizontally level or relatively level, when it is supported by lift 10d. The relative height of the supports 392 in the respective support carriers may be appropriately adjusted. For example, as illustrated in FIGS. 25-26, the support carriers 390 and the respective supports 392 might be inner and outer concentrically disposed cylinders that may be adjusted with respect to each other by aligning appropriate apertures 394 disposed in the elements and then fixing them with an adjustment pin 400. Alternatively, they may engage with a threaded engagement and the supports 392 might be rotated as appropriate to move them vertically up and down in the support carriers. 390.

FIG. 26 illustrates a side view of the lift 10d and shows the dual vertical support formed by the adjustable vertical support 18a and the parallel linear actuator 30. Referring to FIG. 26, an angled support bracket 330 may be secured, such as by welding, in the second outer tube 62a and along the inside surface of the elbow section 202 as shown to further strengthen the juncture at the angle between those elements to handle the weight of a structure without letting the upper platform assembly 20b sag significantly. In one embodiment of the invention, the elbow section 202 is configured such that the angle of the horizontal portion of the elbow section and the vertical portion of the elbow section are positioned and configured to maintain an angle Θ₅ that is exceeds 90° in order to address possible sagging of the upper platform assembly 20b under the weight of the supported structure. For example, an angle Θ₅ in the range of 91°-94° might be used in order for the lift 10 d and the upper platform assembly 20b to maintain generally a horizontal disposition with respect to the ground surface when under the load of a cap, cover, tent or other structure.

For a similar purpose, one embodiment of the invention may configure the vertical support 18a to extend at an angle Θ₆ to the lower platform assembly that is exceeds 90° and may be in the range of 91°-94° in order for the lift 10 d and the upper platform assembly 20b to maintain generally a horizontal disposition with respect to the ground/floor surface when under the load of a structure. Therefore, one or more angles Θ₅, Θ₆ might be used to ensure that under load the lift 10d maintains the structure in a generally horizontal disposition when it is being lifted, lowered, moved or stored with the lift.

The foregoing description has been presented for purposes of illustration and description of this invention. It is not intended to be exhaustive or to limit the invention to the precise form disclosed. Examples given, such as involving the use of phrases such as “for example”, “by way of example” and “an example”, are to be interpreted as non-limiting. Obvious modifications or variations are possible in light of the above teachings. The embodiment was chosen and described in order to best illustrate the principles of the invention and their practical application to thereby enable one of ordinary skill in the art to utilize the invention in various embodiments and forms, and with various modifications as are suited to the particular use contemplated. Although only a limited number of embodiments is explained in detail, it is to be understood that the invention is not limited in its scope to the details of construction and arrangement of components set forth in the preceding description or illustrated in the drawings. The innovation is capable of being practiced or carried out in various ways and in various forms and other embodiments. Also specific terminology was used for the sake of clarity. It is to be understood that each specific term includes all technical equivalents which operate in a similar manner to accomplish a similar purpose. It is intended that the scope of the invention be defined by the claims submitted herewith.

1. A lift apparatus to mount and remove a structure on a vehicle, comprising:
a lower platform assembly configured to be positioned under a vehicle;
an upper platform assembly positioned at a height above the lower platform assembly, the upper platform assembly configured for supporting a structure over a vehicle surface when the lower platform assembly is under a vehicle;
a vertical support mounted to the lower platform assembly, the upper support assembly being mounted to the vertical support, the vertical support extending between the lower platform assembly and upper platform assembly and configured for extending in length for raising and lowering the upper platform assembly with respect to the lower platform assembly;
a linear actuator extending vertically and generally parallel to the adjustable vertical support, the linear actuator coupled at a first end to the lower platform assembly and coupled at a second end to the adjustable vertical support, the actuator being selectively variable in length for changing the length of the adjustable vertical support to raise and lower the upper platform with respect to the vehicle surface.

2. The lift apparatus of claim 1 wherein the vertical support includes a first outer tube coupled to the lower platform assembly and a second outer tube that is coupled to the upper platform assembly, the first and second outer tubes being configured to telescope with respect to each other, the linear actuator second end coupled to the second outer tube to move the second outer tube relative to the first outer tube.

3. The lift apparatus of claim 2 wherein the vertical support includes an inner tube that is configured for being received into the first outer tube and the second outer tube for telescoping the first outer tube and the second outer tube.

4. The lift apparatus of claim 3 wherein the linear actuator second end is coupled to the inner tube to move the second outer tube and the inner tube relative to the first outer tube.

5. The lift apparatus of claim 1 wherein the adjustable vertical support includes a plurality of mount positions for coupling the linear actuator second end to the adjustable vertical support.

6. The lift apparatus of claim 5 wherein the mount positions are provided by a plurality of holes positioned vertically along the second outer tube.

7. The lift apparatus of claim 2 wherein the second outer tube of the vertical support includes a section that extends vertically upwardly and then a section that extends at an angle to the vertical section to engage the upper platform assembly.

8. The lift apparatus of claim 7 wherein the section that extends at an angle to the vertical section extends at an angle that exceeds 90°.

9. The lift apparatus of claim 1 wherein the upper platform assembly includes a cross beam and support arms that extend forwardly from the cross beam, the vertical support being mounted to the cross beam of the upper platform assembly.

10. The lift apparatus of claim 3 further comprising a roller that is secured against the inner tube for rolling against an outer surface of the inner tube during telescoping of the vertical support.

11. The lift apparatus of claim 10 further comprising a bracket element positioned on the first outer tube for securing the roller with the first outer tube for rolling against the inner tube.

12. The lift apparatus of claim 2 further comprising at least one roller positioned inside the inner tube for rolling therein, the rollers being positioned to extend through respective openings in side walls of the inner tube to engage and press against an inside surface of the outer tube.

13. The lift apparatus of claim 12 further comprising a plurality of rollers, the axles of the rollers being positioned to be perpendicular to each other so as to engage multiple adjacent inside surfaces of the first outer tube.

14. The lift apparatus of claim 1 wherein the vertical support is mounted to the lower platform assembly to extend at an angle Θ to the lower platform assembly that exceeds 90°.

15. The lift apparatus of claim 14 wherein the vertical support is mounted to the lower platform assembly to extend at an angle Θ to the lower platform assembly that is in the range of 91°-94°.

16. The lift apparatus of claim 1 wherein the upper support assembly is mounted to the vertical support to extend at an angle Θ to the vertical support that exceeds 90°.

17. The lift apparatus of claim 16 wherein the upper support assembly is mounted to the vertical support to extend at an angle Θ to the vertical support that is in the range of 91°-94°.

18. The lift apparatus of claim 1 wherein the lower platform assembly has a U-shaped construction including two legs that are coupled by a base member, the vertical support mounted to the base member.
